(19) United States
(12) Patent Application Publication
(10) Pub. No.: US 2003/0077476 A1
(43) Pub. Date: Apr. 24, 2003

(54) Stacked sheet metal laminate

(76) Inventor: Kurt Reutlinger, Stuttgart (DE)

Correspondence Address: Striker Striker & Stenby, 103 East Neck Road, Huntington, NY, 11743, US

(21) Appl. No.: 10/149,811

(22) PCT Filed: Aug. 18, 2001
(86) PCT No.: PCT/DE01/03169

(30) Foreign Application Priority Data
Oct. 17, 2000 (DE) 100514995

(51) Int. Cl. C25D 5/10; B32B 15/00

(52) U.S. Cl. 428/615

(57) ABSTRACT

Lamination packet, in particular for electrical machines and devices, having a plurality of laminations (2) arranged flat against each other, and having at least one thermal-conduction ply arranged flat against one lamination (2), whereby the thermal conductivity of the thermal-conduction ply is greater than the thermal conductivity of the lamination (2).

The invention concerns a lamination packet, in particular for electrical machines and devices.

Various cooling systems for cooling electrical machines are known, which said cooling systems are used for specific applications. In the case of simple machines, an open design is often selected for cooling purposes. Due to the open design, an air current can be directed through the machine past the active parts, which said active parts represent the heat sources in the machine. In this case, the heat sources are typically the windings in which the greatest losses occur. The cooling air current enters the machine and flows directly past the windings and the laminations, absorbing the heat. When the cooling air stream leaves the machine, it takes the heat with it and dissipates it into the environment. The cooling air current in this case can be natural convection, or it can be produced by a fan. In machines having a closed design, it is not possible to direct a cooling air current through the machine and past the active components. In the case of these machines, the heat from the windings is dissipated into the housing via the stator. In the case of some of the larger machines, an internal cooling cycle is also provided in which gas is circulated for cooling purposes. Internal cooling cycles are expensive to produce.

The invention is based on the object of creating a lamination packet for an electrical machine to improve the cooling of the machine.

The object is attained by means of the features of claim 1. The core of the invention is to provide thermal-conduction plies between the individual laminations in a lamination packet, the thermal conductivity of which is greater than the thermal conductivity of the individual laminations.

Further advantageous embodiments of the invention result from the dependent claims.

Additional features and details of the invention result from the description of two exemplary embodiments with reference to the drawings.

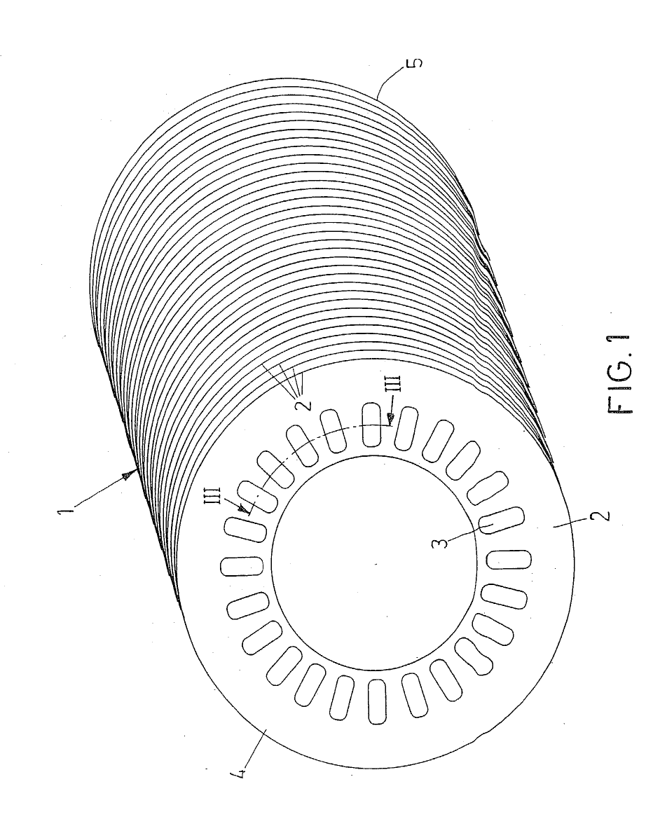

FIG. 1 shows a top view of a lamination packet of a machine stator according to a first exemplary embodiment,

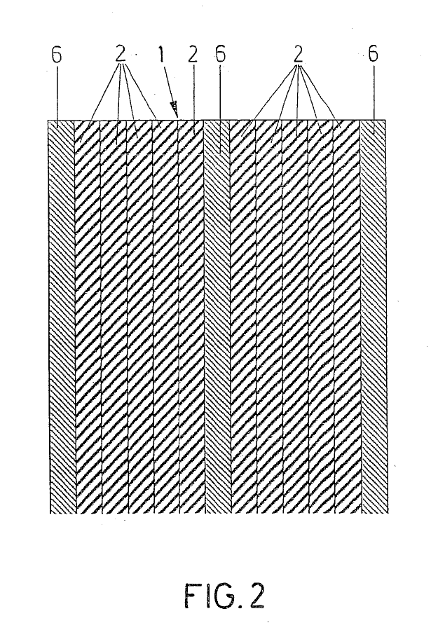

FIG. 2 is a cross-sectional view of the lamination packet according to FIG. 1,

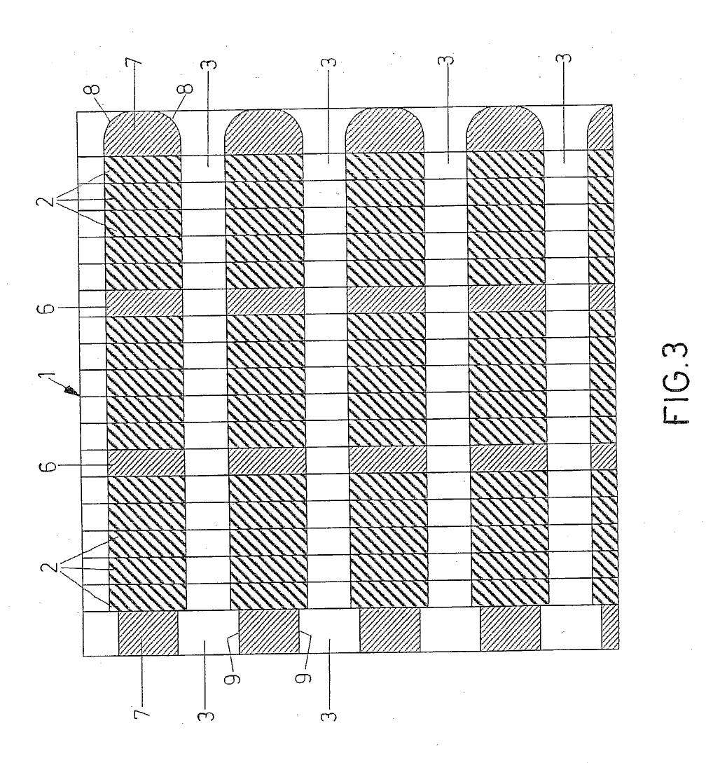

FIG. 3 is a cross-sectional view according to the intersecting line III-III in FIG. 1, and

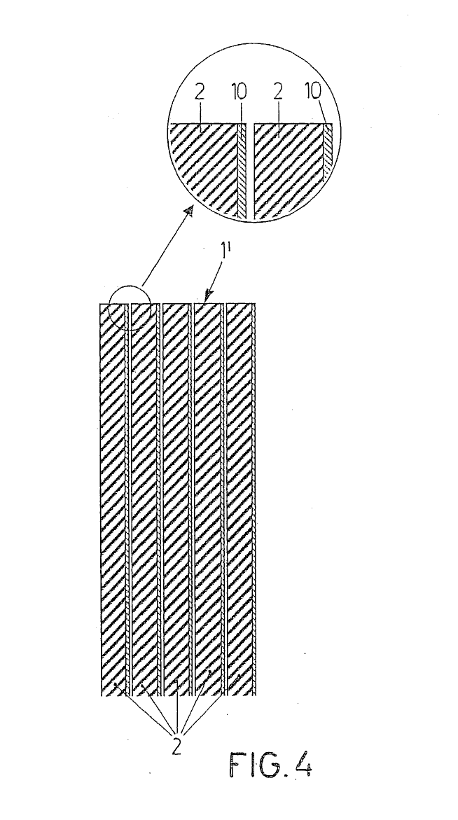

FIG. 4 is a cross-sectional view of a lamination packet according to a second exemplary embodiment.

Lamination packets 1 are used in electrical machines such as electric motors and generators, and in electrical devices such as transformers, which said lamination packets have winding wire wound partly around them. Magnetic fields are induced when current flows through the winding wire, which said magnetic fields are guided partly or entirely in the lamination packet 1. A typical lamination packet 1 is shown in FIG. 1. This is the fixed machine stator of an electric motor. The individual laminations 2 are designed in the shape of washers for this purpose and comprise radially outwardly extending slots 3 distributed around the circumference, which said slots of the various laminations 2 are superimposed on each other. The slots 3 accommodate the winding wire that is guided from one slot 3 into the next slot on both outwardly-facing ends 4 and 5. The individual laminations 2 are composed of steel sheets alloyed with silicon to reduce specific losses. The specific thermal conductivity of the laminations 2—also referred to as “dynamo sheets”—typically lies in the range of 20 to 30 W/Km. The laminations 2—which lie flat against each other and are interconnected by means of adhesion, for example—are insulated with respect to one another, which is often achieved by applying a layer of varnish. As shown in FIG. 2, a thermal-conduction plate 6 designed as a thermal-conduction ply is situated at regular intervals between the laminations 2. The plate 6 is arranged flat between the laminations 2 and is in immediate contact with said laminations. The plate 6 is composed of a material that has a greater thermal conductivity than the material of the laminations 2. Aluminium is a material that is particularly well-suited for this application. Aluminium has very good thermal conductivity, i.e., 230 W/Km. Other materials with high thermal conductivity can also be used, however, such as copper, silver, and gold. In the case of the arrangement shown in FIG. 2, five laminations 2 are separated by one plate 6 in each case. The distance between the individual plates 6 is selected as a function of the desired thermal conductivity of the lamination packet 1 and the magnetic fields to be guided therein. When every tenth lamination 2 is replaced with a plate 6 made of aluminium, the thermal conductivity of the lamination packet 1 doubles as compared to a lamination packet that has only one lamination 2. Due to the plates 6 made of a nonmagnetic material, the lamination factor, i.e., the portion of magnetic iron in a lamination packet 1 per unit volume, is reduced. The good electrical conductivity of the plates 6 does not increase the eddy-current losses of the associated electrical machine, however, because the magnetic flux is not guided in the aluminium, but rather parallel thereto in the dynamo sheet. If a magnetic flux should occur in the axial direction and hereby cause eddy currents in the plate 6, then radially extending slots in the nature of a comb can be provided in the plate 6 in order to reduce the eddy-current losses. This is significant in particular in the case of plates 6 arranged on the ends 4 and 5, because axial field portions can also occur there under the winding heads due to the ampere-turns of the winding heads. Cover plates 7 designed as thermal-conduction plies are provided on the ends 4 and 5 of the lamination packet 1, which said cover plates are designed thicker than the plates 6. In the case of a lamination packet 1 that does not have plates 6, it is often sufficient to simply provide cover plates 7 at both ends 4 and 5 in order to increase the thermal conductivity. To better accommodate the winding wire, the cover plates 7 can comprise rounded corners 8 between the slots 3, so that the winding wire can be wound around without becoming damaged while ensuring extensive contact and, therefore, high heat transmission to the cover plate 7. It is also possible to provide recoiling edges 9 across from the slots 3 to make it easier to wind the winding wire around the cover plate 7. At the same time, the thicker cover plates 7 increase the stability of the lamination packet 1.

The function of the lamination packet 1 will be described hereinbelow. In the case of closed machines, in particular machines without an extra internal cooling cycle, the heat dissipation from the site of the loss to the heat sink takes place by means of heat conduction. The heat sink can be formed by a housing with water cooling, for example. The heat therefore flows from the windings, through the insulation layers of the winding wires, and into the lamination packets, which often comprise projections designed in the shape of teeth. The heat then flows from these teeth via the stator yoke into the housing, where it is transported away by means of the coolant. In the case of heat conduction, the teeth represent a bottleneck. A large portion of the heat loss is transported via the teeth. In the case of the lamination packet 1, the thermal conductivity of the packet 1 is increased greatly overall, so that the heat can be better dissipated from the packet 1 and, in particular, from the teeth to the stator yoke and the housing. A good thermal connection of the windings to the housing is therefore produced. In this fashion, the temperature level in the machine can either be reduced and, as a result, the service life and efficiency can be increased. Or, the output of the machine can be increased until the temperature level of the original machine having a lamination packet without a thermal-conduction ply is achieved.

A second exemplary embodiment of the invention will be described hereinbelow with reference to FIG. 4. Identical parts are labelled with the same reference numerals as in the first exemplary embodiment. The description of said first exemplary embodiment is referred to herewith. Different parts that perform the same type of function are labelled with the same reference numerals and a superscript mark. The main difference from the first exemplary embodiment lies in the fact that the thermal-conduction ply is designed as a thermal-conduction layer 10 that is provided on one part or on each lamination 2. The thermal-conduction layer 10 can be created by means of adhesion, vapor deposition, or rolling-on, or electrodepositing, in particular of aluminium, onto a lamination 2. An anodized coating made of aluminium oxide can be applied to the thermal-conduction layer 10 to insulate the thermal-conduction layer 10 from the adjacent lamination 2. The advantage of this is the fact that non-insulated laminations 2 can be used. Laminations 2 having both improved thermal conductivity and insulation on one side can therefore be produced. The laminations 2 and the thermal-conduction layers 10 are in direct physical contact with each other, i.e., there is no air gap between the layers 10 and the laminations 2. The layers 10 can also be arranged between the laminations 2, of course, without being interconnected directly with a lamination 2.

What is claimed is:

1. A lamination packet, in particular for electrical machines and devices, having
a) a plurality of laminations (2) arranged flat against each other, and
b) at least one thermal-conduction ply arranged flat against one lamination (2),
c) whereby the thermal conductivity of the thermal-conduction ply is greater than the thermal conductivity of the lamination (2).

2. The lamination packet according to claim 1,
wherein the thermal-conduction ply is composed of aluminium, copper, silver, gold, or an alloy containing one of these elements.

3. The lamination packet according to claim 1 or 2,
wherein the thermal-conduction ply is designed as a thermal-conduction layer (10) arranged on a lamination (2).

4. The lamination packet according to claim 3,
wherein the thermal-conduction layer (10) is interconnected with the lamination (2) by means of adhesion, vapor deposition, or rolling-on.

5. The lamination packet according to claim 3 or 4,
wherein a thermal-conduction layer (10) is formed on every lamination (2).

6. The lamination packet according to one of the claims 3 through 5,
wherein an insulating layer comprised of metallic oxide is provided on the thermal-conduction layer (10).

7. The lamination packet according to claim 1 or 2,
wherein the thermal-conduction ply is designed as a thermal-conduction plate (6).

8. The lamination packet according to claim 7,
wherein thermal-conduction plates (6) are arranged in periodic intervals between the laminations (2).

9. The lamination packet according to one of the preceding claims,
wherein a thermal-conduction cover plate (7) is provided on the lamination (2).

10. The lamination packet according to one of the preceding claims,
wherein the thermal-conduction ply is designed with slots.
